(19) United States
(12) Patent Application Publication
(10) Pub. No.: US 2015/0012520 A1
(43) Pub. Date: Jan. 8, 2015

(54) METHOD AND APPARATUS FOR PERFORMING SEARCH FUNCTION IN PORTABLE TERMINAL

(71) Applicant: Samsung Electronics Co., Ltd., Suwon-si (KR)

(72) Inventors: Jinwan AN, Daegu (KR); Jeongseob KIM, Daegu (KR); Jiwoong OH, Seoul (KR)

(21) Appl. No.: 14/324,843

(22) Filed: Jul. 7, 2014

(30) Foreign Application Priority Data
Jul. 8, 2013 (KR) 10-2013-0079379

(51) Int. Cl. G06F 7/24; G06F 17/30

(52) U.S. Cl. CPC G06F 7/24; G06F 17/3087
USPC 707/711; 707/754

(57) ABSTRACT

A method and an apparatus for performing a search function by selecting a specific text displayed on a screen are provided. The method includes selecting a text displayed on a screen, extracting search keywords from the selected text and displaying the extracted search keywords, recognizing selection of at least one of the displayed search keywords, and performing a search using the at least one selected search keyword. Accordingly, a user can easily and conveniently search for desired information without directly inputting a search keyword in the search window.

### CROSS-REFERENCE TO RELATED APPLICATION(S)

This application claims the benefit under 35 U.S.C. §119(a) of Korean patent application filed on Jul. 8, 2013 in the Korean Intellectual Property Office and assigned Serial number 10-2013-0079379, the entire disclosure of which is hereby incorporated by reference.

### TECHNICAL FIELD

The present disclosure relates to a method and an apparatus for performing a search function in a portable terminal. More particularly, the present disclosure relates to a method and an apparatus for performing a search function by selecting a specific text displayed on a screen.

### BACKGROUND

Currently, functions of a portable terminal are becoming various due to development of information communication technologies and semiconductor technologies. In particular, the portable terminal provides various functions such as a wireless Internet service, a memo writing function, and a media file playback function in addition to a wireless communication function to provide users with conveniences. Among the various functions provided by the portable terminal according to the related art, an information search function through connection to wireless Internet becomes an essential function of the portable terminal and is gradually becoming more important.

The Internet search function of the portable terminal according to the related art is operated by inputting a specific text in a search window of a search engine and executing a search by the user. However, in a general method, when a text that is to be searched for is discovered from a search result (e.g., content of an article) displayed on a screen, the user must input a corresponding word to the search window again to perform a search, which is inconvenient. In particular, when the user desires to combine and search for several words in a specific sentence, the user is generally required to input the content to the search window while memorizing the content, which makes the task more inconvenient. In particular, if the text to be searched for by the user includes many words, the user may have difficulty memorizing all of the words of the text to be searched at one time. Thus, because a text that is to be searched for must be directly input to a search window in an existing Internet search method using the portable terminal, various inconveniences occur.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for, when a search of information related to a text displayed on a screen is necessary, allowing a user to search for desired information directly by using the text.

In accordance with an aspect of the present disclosure, a method of performing a search function in a portable terminal is provided. The method includes selecting a text displayed on a screen, extracting search keywords from the selected text and displaying the extracted search keywords, recognizing selection of at least one of the displayed search keywords, and performing a search using the at least one selected search keyword.

In accordance with another aspect of the present disclosure, an apparatus for performing a search function in a portable terminal is provided. The apparatus includes a display unit configured to display a text and search keywords extracted from the text, a touch panel configured to receive a touch gesture generating signal for selecting the text or the extracted search keywords, a control unit configured to extract search keywords, to detect selection of at least one of the extracted search keywords, and to perform a search with the at least one selected search keyword, a storage unit configured to store programs and instructions for performing the search, and a wireless communication unit configured to support wireless communications for performing the search.

The method and the apparatus for performing a search function in a portable terminal allows a user to easily search for information related to a text displayed on a screen. Accordingly, the user can easily and conveniently search for desired information without directly inputting a search keyword in the search window.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram showing a portable terminal according to an embodiment of the present disclosure;

FIG. 2 is a flowchart showing a process of performing a search with a search keyword extracted when a text is selected in a portable terminal according to an embodiment of the present disclosure;

FIGS. 3A, 3B, and 3C are views showing a process of performing a search with a search keyword extracted when a text is selected in a portable terminal according to an embodiment of the present disclosure;

FIG. 4 is a flowchart showing a process of extracting search keywords from a selected text and displaying a search keyword according to an embodiment of the present disclosure; and

FIGS. 5A and 5B are views showing a process of displaying a search keyword when a search is performed according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

According to various embodiments of the present disclosure, a portable terminal may be an electronic device.

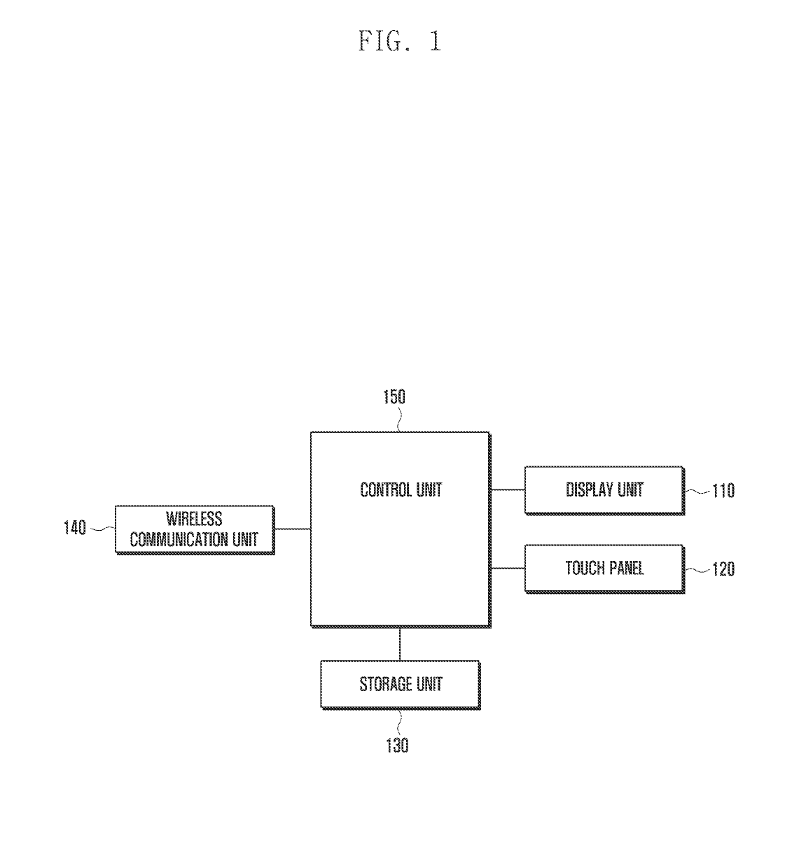

FIG. 1 is a schematic diagram showing a portable terminal according to an embodiment of the present disclosure.

Referring to FIG. 1, according to various embodiments of the present disclosure, the portable terminal includes a display unit 110, a touch panel 120, a storage unit 130, a wireless communication unit 140, and a control unit 150. According to various embodiments of the present disclosure, the display unit 110 and the touch panel 120 may be disposed in a touch screen.

According to various embodiments of the present disclosure, the display unit 110 may include a Liquid Crystal Display (LCD), an Organic Light Emitting Diode (OLED), an Active Matrix Light Emitting Diode (AMOLED), and/or the like. The display unit 110 may visually provide the user with various information such as a menu, input data, and function setting information of a portable terminal. According to various embodiments of the present disclosure, the user selects a text (e.g., a title of an Internet article), the display unit 110 may display several search keywords extracted from the text on a screen. The display unit 110 may display a search keyword selected from several search keywords while emphasizing the selected search keyword. The display unit 110 may display a result obtained by performing a search with the selected search keyword on the screen.

The touch panel 120 is a unit for detecting a touch input of the user. The touch panel 120 may be driven through a capacitive overlay method, a resistive overlay method, an infrared beam method, and/or the like. Alternatively or in addition, the touch panel 120 may be formed through any method other than the above-described methods, by which a contact or pressure of an object may be detected. The touch panel 120 generates an signal (e.g., a touch event) in response to the user gesture on the touch panel 120. For example, the touch panel may generate an analog signal in response to the user gesture on the touch panel 120. The AD converts the analog signal into a digital signal and transmits the digital signal to the control unit 150.

According to various embodiments of the present disclosure, when an additional search is to be performed on a web page, the touch panel 120 may transmit an electrical signal of a touch (e.g., a long touch) performed to select a text to the control unit 150. Then, when the user selects the text, various search keywords are displayed on the screen. According to various embodiments of the present disclosure, some of the displayed search keywords may be selected, in which case the touch panel 120 may transmit a touch generation signal to the control unit 150 when a touch for selecting a search keyword is generated by the user.

The storage unit 130 serves to store programs and data necessary for an operation of the portable terminal According to various embodiments of the present disclosure, some the storage unit 130 may store programs associated with (e.g., necessary for) an Internet search function using the portable terminal. The storage unit 130 may select a text from the screen on which a web page or an electronic document is displayed and may store the programs and data associated with (e.g., necessary for) performing the search function. In more detail, when the user selects a text, the storage unit 130 may store separate words of the selected text and store programs and data associated with (e.g., necessary for) displaying several search keywords. If some of the search keywords are selected and a search instruction is input, the storage unit 130 may store programs and data associated with (e.g., necessary for) performing a search with the selected search keywords.

The wireless communication unit 140 performs a wireless communication function of the portable terminal. The wireless communication unit 120 may include an Radio Frequency (RF) transmitter for raising and amplifying a frequency of a transmitted signal, and an RF receiver for low-noise amplifying a received signal and lowering a frequency of the received signal. The wireless communication unit 140 may include a mobile communication module such as Long Term Evolution (LTE), Code Division Multiple Access (CDMA), and/or the like, a digital broadcasting module such as Digital Multimedia Broadcasting (DMB), Digital Video Broadcasting (DVB), and/or the like, a wireless Internal communication module such as WiFi, Wibro, and/or the like, and a short-range communication module such as Near Field Communication (NFC), Bluetooth, and/or the like.

According to various embodiments of the present disclosure, the wireless communication unit 140 may support a wireless Internet communication function associated with (e.g., necessary for) searching for a search keyword selected by the user in a portable terminal.

The control unit 150 controls an overall operation of the portable terminal. According to various embodiments of the present disclosure, the control unit 150 may control a process of driving a wireless Internet application. The control unit 150 may control the display unit 110 such that when the user performs a search for desired information while the Internet application is executed, a search result on the information is displayed on the display unit 110. The control unit 150 may control the display unit 110 such that various electronic documents including a text as well as a web page are displayed on the display unit 110. When a web page including a text, an electronic document, and/or the like is displayed through the display unit 110, the control unit 150 may detect a location at which a touch is generated through a signal transmitted from the touch panel 120 and may determine whether an arbitrary text existing on the screen is selected. According to various embodiments of the present disclosure, when an arbitrary text is selected on the screen, the control unit 150 extracts a search keyword from the arbitrary text and controls the display unit 110 such that the extracted search keyword is displayed on the screen. Then, the control unit 150 may extract words included in the text with a search keyword. The control unit 150 may control a specific search keyword to be displayed emphatically in relation to the remaining search keywords. For example, the control unit 150 may control such that at least one of a color, a size, a font, and an inclination of a specific search keyword selected from a plurality of search keywords displayed on the screen by the user is displayed while being distinguished from the other search keywords. According to various embodiments of the present disclosure, when a specific search keyword is selected and a search instruction is input by the user, the control unit 150 controls a search engine application such that a search service is performed with the selected specific search keyword.

Hereinafter, a process of extracting search keywords from a specific text according to selection of the user and performing a search with a search keyword selected from the extracted search keywords will be described.

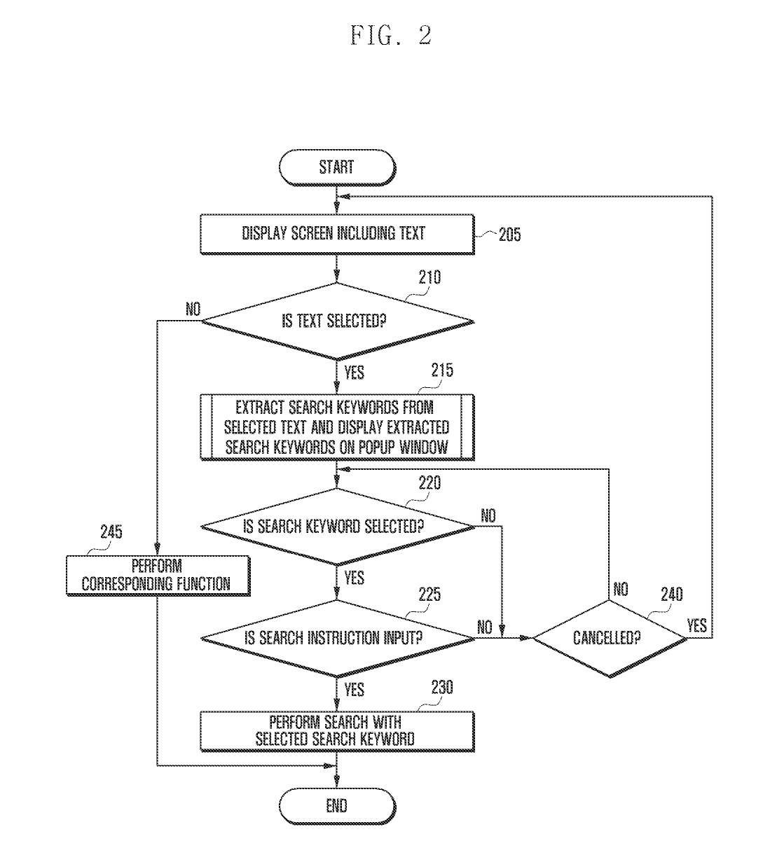

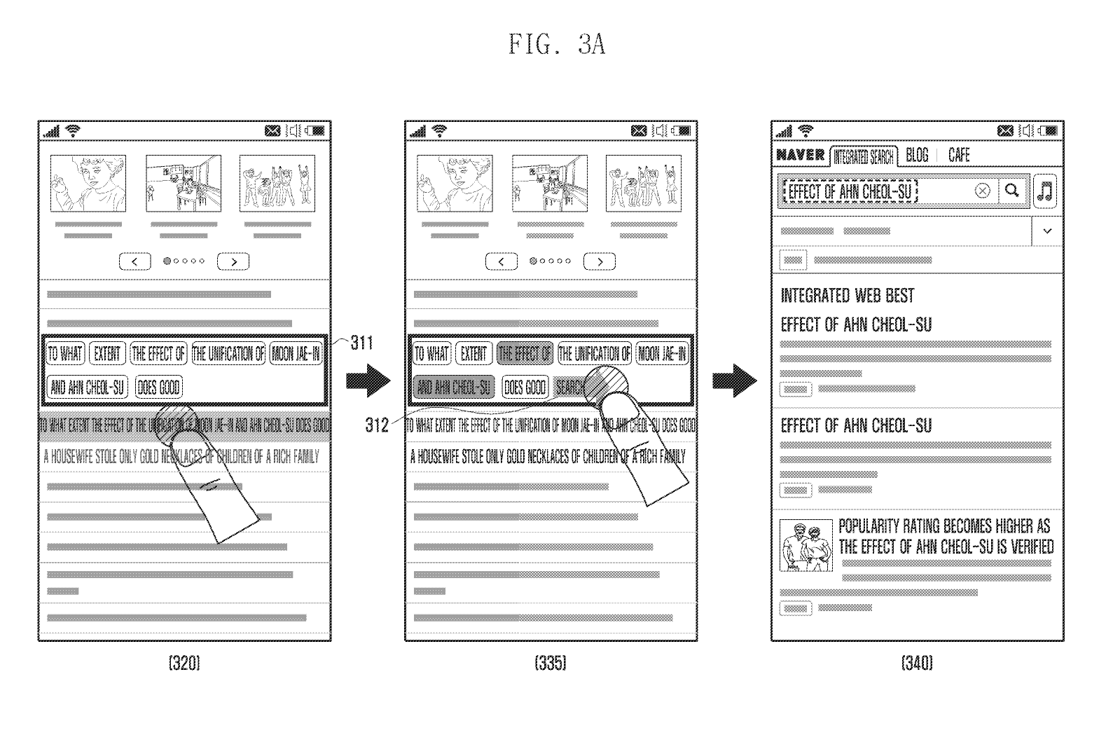

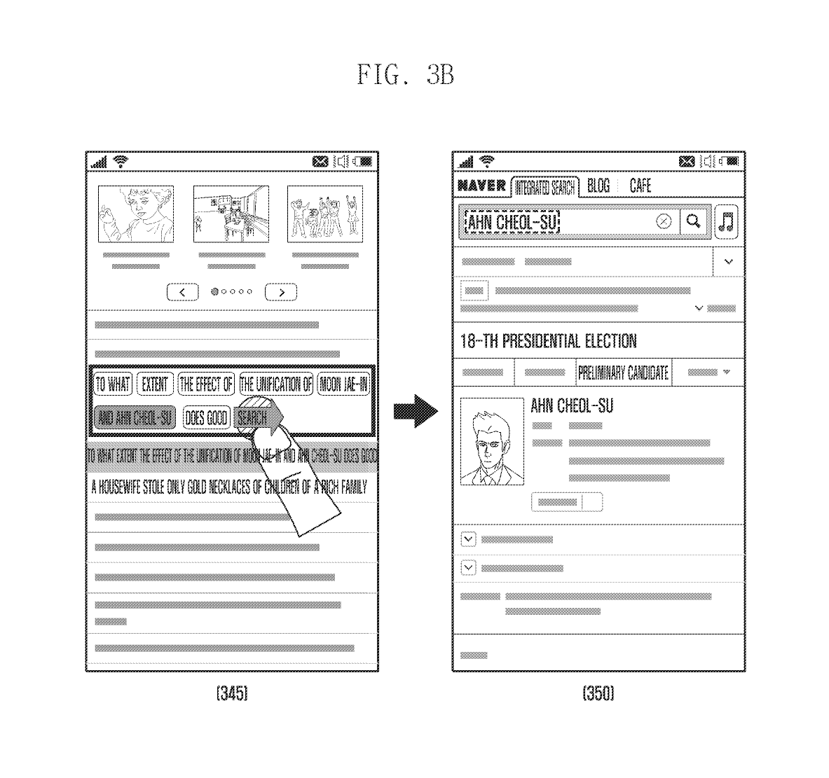

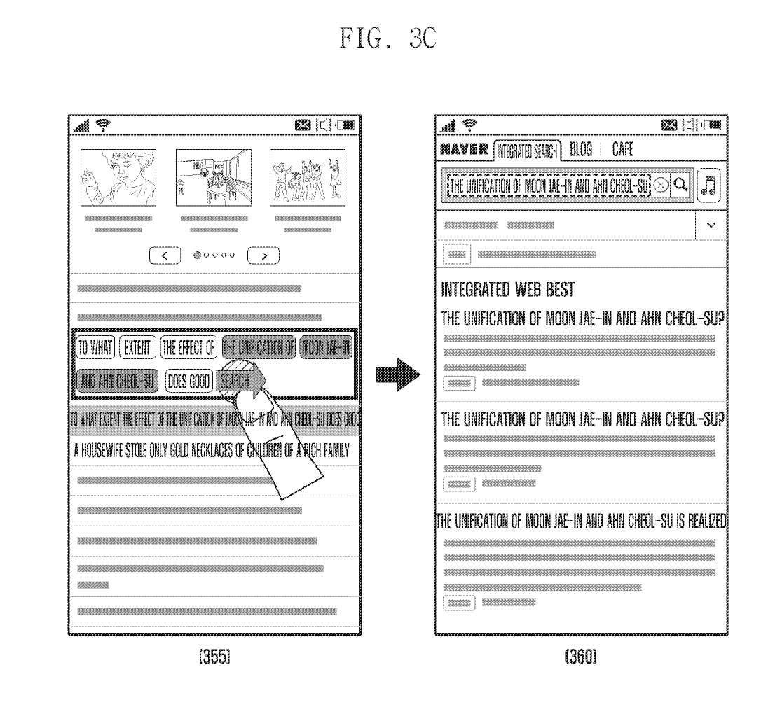

FIG. 2 is a flowchart showing a process of performing a search with a search keyword extracted when a text is selected in a portable terminal according to an embodiment of the present disclosure. FIGS. 3A, 3B, and 3C are views showing a process of performing a search with a search keyword extracted when a text is selected in a portable terminal according to an embodiment of the present disclosure.

Referring to FIG. 2, at operation 205, the control unit 150 may display a screen including a text. According to various embodiments of the present disclosure, the screen may be a main screen of a specific search engine or a screen for displaying text information such as a body of an article, an electronic document, and/or the like. If a text is displayed on the screen of the portable terminal, the control unit 150 may detect generation of a touch gesture for selecting the text.

At operation 210, the control unit 150 may determine whether text is selected. For example, the touch gesture for selecting the text may be a long touch for maintaining a touch state for a predetermined time period or longer from a time point when a touch is generated. The text may be a combination of characters including letters, symbols, and numbers, may be a plurality of listed words or sentences, and/or the like. For example, when a long touch is performed by the user at a point at which a specific sentence is located in the contents of the article. The selected text may be the above sentence.

If the control unit 150 determines that a specific text is not selected at operation 210, then the control unit 150 may proceed to operation 245 at which the control unit 150 may perform a corresponding function. For example, the control unit 150 may enlarge or reduce the screen, select an image or a video, and/or the like.

If the control unit 150 determines that text is selected at operation 210, then the control unit 150 may proceed to operation 215 at which the control unit 150 may extract search keywords from the selected text. The control unit 150 may display the extracted search words on a popup window, or the like. Referring to FIG. 3A, as an example, in response to generation of a touch gesture for selecting a specific text is detected, the control unit 150 may perform a process of extracting search keywords from the text selected, and displaying the extracted search keywords on a popup window 311.

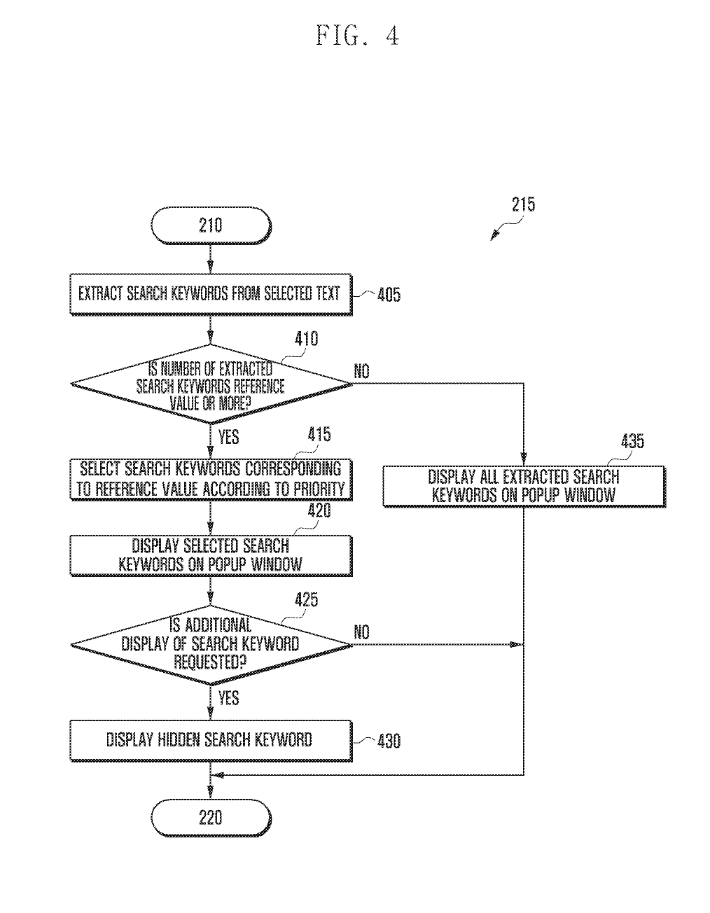

Operation 215 will be described below with reference to FIG. 4. According to various embodiments of the present disclosure, the displayed search keyword may be words constituting the selected text. The control unit 150 may separate the words constituting the text and display search keywords separately. According to various embodiments of the present disclosure, the search keywords may be displayed in letter boxes, and the letter boxes in which the search keywords are written may be displayed on the popup window 311 overlaid on the screen. A process of displaying the search keywords by the control unit 150 at operation 215 may include a process of popping up a popup window 311 and displaying the letter boxes in which the search keywords are written in the popup windows 311.

Thereafter, at operation 220, the control unit 150 may determine whether a search keyword is selected.

If the control unit 150 determines that the search keyword is selected in operation 220, then the control unit 150 may proceed to operation 225 at which the control unit 150 determines whether a search instruction is input. As an example, in response to a search keyword is selected, the control unit 150 may emphasize and display the search keyword to inform the user of the selected search keyword. According to various embodiments of the present disclosure, an example for emphasizing the search keyword may include a method of changing a background color of the search keyword. Alternatively, when a search keyword is selected, the control unit 150 may change and display a color, a size, a font, an inclination of the selected search keyword, and/or the like.

At operation 225, the control unit 150 may determine whether a search instruction is input. Referring to FIG. 3A, as an example, the user may touch and input a search button 312 displayed on the popup window 311 when at least one search keyword is selected. Alternatively, the user may long-touch a search keyword finally selected after a search keyword to be searched is selected to input a search instruction.

If the control unit 150 determines that the search instruction is input at operation 225, then the control unit may proceed to operation 230 at which the control unit 150 may perform a search. For example, the control unit 150 may perform a search by applying the selected search keyword. A search engine for performing the search may be set by the user in advance. Alternatively, the search engine for performing the search may be a basic search engine provided by the portable terminal. Thus, if the search instruction is requested, the control unit 150 may perform a search function for the search keyword through a predetermined search engine and display the result. If the search is performed, the process of FIG. 2 may be ended.

In contrast, if the control unit 150 determines that a search keyword is not selected at operation 220, then the control unit 150 may proceed to operation 240 at which the control unit 150 determines whether a cancel request is input. For example, when a search keyword is not selected, the control unit 150 may determine whether a cancel request is generated by the user. According to various embodiments of the present disclosure, a method of requesting a cancel may include a method of inputting a cancel key or touching an area other than the popup window 311.

If the control unit 150 determines that a search instruction is not input at operation 225, then the control unit 150 may proceed to operation 240 at which the control unit 150 determines whether a cancel request is input.

If the control unit 150 determines that a cancel request is input at operation 240, then the control unit 150 may return to operation 205. For example, in response to a cancel instruction being input at operation 240, the control unit 150 erases the popup window 311 from the screen and returns to operation 205.

In contrast, if the control unit 150 determines that a cancel instruction is not input at operation 240, then the control unit 150 may return to operation 220 at which the control unit 150 may determine whether a search keyword is selected. Thereafter, according to various embodiments of the present disclosure, the user may add or change a search keyword. For example, the control unit 150 may determine whether another search keyword other than the search keyword selected before is additionally selected at operation 220. According to various embodiments of the present disclosure, the control unit 150 may determine whether an additionally selected search keyword exists and may emphasize and display the additionally selected search keyword. When operation 220 is performed via operation 225 and operation 240, the control unit 150 may determine whether the search keyword selected before is selected again. In this case, the control unit 150 may cancel selection of the search keyword selected before and release display of an emphasis.

Referring to FIG. 3A, reference numeral 320 of FIG. 3A indicates a screen on which a web page is displayed. Further, a state in which a specific text displayed in the web page is selected and a search keyword is displayed on the popup window 311. If a touch gesture (e.g., a long touch) is performed on a text to be searched for by the user, the control unit 150 determines that the text is selected. If the text is selected, the control unit 150 may extract a search keyword from the selected text and may display the extracted search keyword. As illustrated in FIG. 3A, the selected text is ‘To what extent the effect of the unification of Moon Jae-In and Ahn Cheol-Su does good’. As illustrated in FIG. 3A, the search keywords displayed on the screen is ‘To what’, ‘extent’, ‘the effect of’, ‘the unification of’, ‘Moon Jae-In’, ‘and Ahn Cheol-Su’, and ‘does good’. As shown in reference 320 of FIG. 3A, the control unit 150 may extract the search keywords from the selected text in units of words, phrases, and/or the like. Reference numeral 335 indicates a screen having a state in which the user selects specific search keywords from the search keywords display on the popup window 311. Thereafter, as illustrated in FIG. 3A, the selected search keywords are ‘the effect of’ and ‘and Ahn Cheol-Su’, and the search keyword may be emphasized and displayed. The selected searched words may be emphasized by adding shading, highlighting, and/or the like to the search keywords. According to various embodiments of the present disclosure, the control unit 150 may use a method of changing a color, a size, a font, an inclination, and a background color of a selected search keyword to emphasize the search keyword. In addition, the control unit 150 may use another method for informing the user of selection of a search keyword. The emphasized search keyword may return to the original state if the selection of the search keyword is cancelled. If at least one search keyword is selected, the user may input a search instruction. In order to input the search instruction, a method of touching a search button 312 displayed in an area of the popup window 311 or a method of long-touching a finally selected search keyword may be used.

Reference numeral 340 of FIG. 3A corresponds to a screen showing a result obtained by performing a search while taking ‘the effect of Ahn Cheol-Su’ as a search keyword when the search instruction is requested. As illustrated in FIG. 3A, ‘the effect of’ and ‘Ahn Cheol-Su’ that are the selected search keywords are input to the search window of the search engine together.

Referring to FIG. 3B, in a similar method, the number of selected search keywords may be adjusted. Reference numeral 345 of FIG. 3B corresponds to a screen in which only a search keyword of ‘Ahn Cheol-Su’ is emphasized and displayed on the screen. As illustrated in FIG. 3B, the user touches the search button 312 and inputs a search instruction. When only the search keyword of ‘Ahn Cheol-Su’ is selected in this way, a search may be performed while taking ‘Ahn Cheol-Su’ as a search keyword. Reference numeral 350 of FIG. 3B corresponds to a screen showing results of the search in which ‘Ahn Cheol-Su’ is used as a search keyword.

FIG. 3C shows a state of selecting three search keywords. Reference numeral 355 of FIG. 3C corresponds to a screen in which search keywords of ‘the unification of’, ‘Moon Jae-In’, ‘and Ahn Cheol-Su’ are selected. In this way, the user may select three search keywords and request a search instruction. Reference numeral 360 of FIG. 3C corresponds to a screen showing results when the control unit 150 may perform a search with a search keyword of ‘the unification of Moon Jae-In and Ahn Cheol-Su’.

FIG. 4 is a flowchart showing a process of extracting search keywords from a selected text and displaying a search keyword according to an embodiment of the present disclosure.

Referring to FIG. 4, at operation 405, the control unit 150 may extract search keywords from a text selected after operation 210.

At operation 410, the control unit 150 may determine whether the number of the extracted search keywords is greater than or equal to a reference value.

If the control unit 150 determines that the number of extracted search keywords is greater than or equal to the reference value at operation 410, then the control unit 150 may proceed to operation 415 at which the control unit 150 may select search keywords corresponding to the reference value. For example, in response to the control unti 150 determining that the number of the search keywords is greater than or equal to the reference value, the control unit 150 may select search keywords the number of which corresponds to the reference value according to a priority. According to various embodiments of the present disclosure, a reference of the priority may include at least one of, for example, a search frequency in a search engine, an extraction order of search keywords, a frequency in a text, user settings or configurations, user preferences, and/or the like.

Thereafter, at operation 420, the control unit 150 may display the search keywords selected. As an example, the control unit 150 may display the selected search keywords on the popup window 311. For example, a case in which the reference value is 5 and the reference of the priority is a search frequency in a search engine will be described. First, the control unit 150 determines whether the number of the extracted search keywords is greater than or equal to 5. When the number of the extracted search keyword is greater than or equal to 5, five search keywords may be selected to be displayed. According to various embodiments of the present disclosure, five search keywords may be selected in the order corresponding to the highest search frequencies in the set search engine. The search frequency may correspond to a search frequency of the user, a search frequency in relation to use of the portable terminal, a search frequency in relation to a search engine (e.g., the portable terminal may connect to a server that computes and/or stores search frequencies of terms, phrases, and/or the like). Thereafter, the selected five search keywords may be displayed on the popup window 311.

Thereafter, at operation 425, the control unit 150 may determine whether an additional display request for a search keyword is generated. The user may request an an additional display of a search keyword when a hidden search keyword of the extracted search keywords is to be displayed. A method of requesting an additiional display of a search keyword may be a method of enlarging the size of the popup window 311 by dragging an edge of the popup window 311. Alternatively, when a scroll bar is present at one side of the popup window 311, the user may move the scroll bar to additionally display the search keyword. When a search keyword adding menu 511 is displayed at one side of the popup window 311, an additional display of a search keyword may be requested by touching the search keyword adding menu 511. In addition, various methods may be used to request an additional display of a search keyword.

If the control unit 150 determines that an additional display request for a search keyword is not generated at operation 425, then the control unit 150 may end the process of FIG. 4 and proceed to operation 220.

In contrast, if the control unit 150 determines that an additional display request for a search keyword is generated at operation 425, then the control unit 150 may proceed to operation 430 at which the control unitl 50 may display a hidden search keyword. For example, in response to an additional display request for a search keyword, the control unit 150 may display a hidden search keyword. According to various embodiments of the present disclosure, the control unit 150 may enlarge the size of the popup window 311 in response to an additional display request for a search keyword. According to various embodiments of the present disclosure, the control unit 150 may add and display a predetermined number of search keywords hidden in the enlarged popup window, or may display all the hidden search keywords. Thereafter, the control unit 150 may end the process of FIG. 4 and proceed to operation 220 of FIG. 2.

Meanwhile, if the control unit 150 determines that the number of search keywords extracted is not greater than or equal to a reference value at operation 410, then the control unit 150 may proceed to operation 435 at which the control unit 150 may display all the extracted search keywords on the popup window 311. Thereafter, the control unit 150 may end the process of FIG. 4 and proceed to operation 220 of FIG. 2.

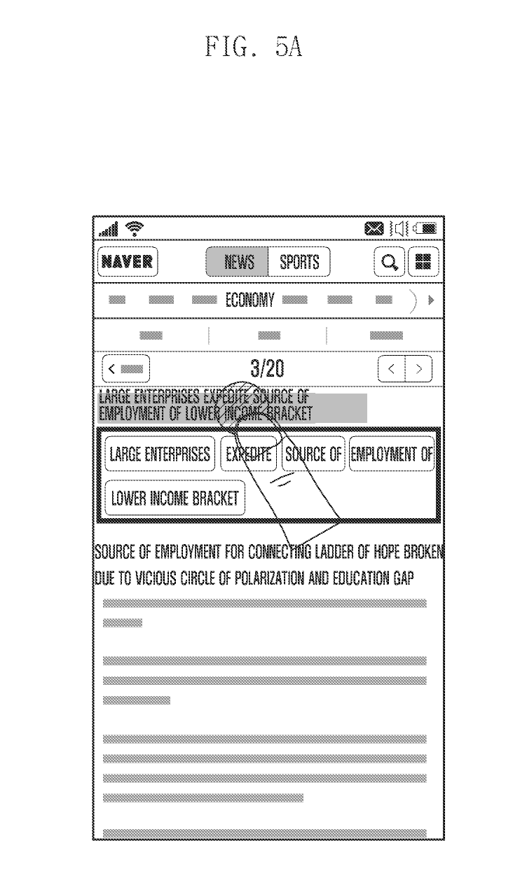

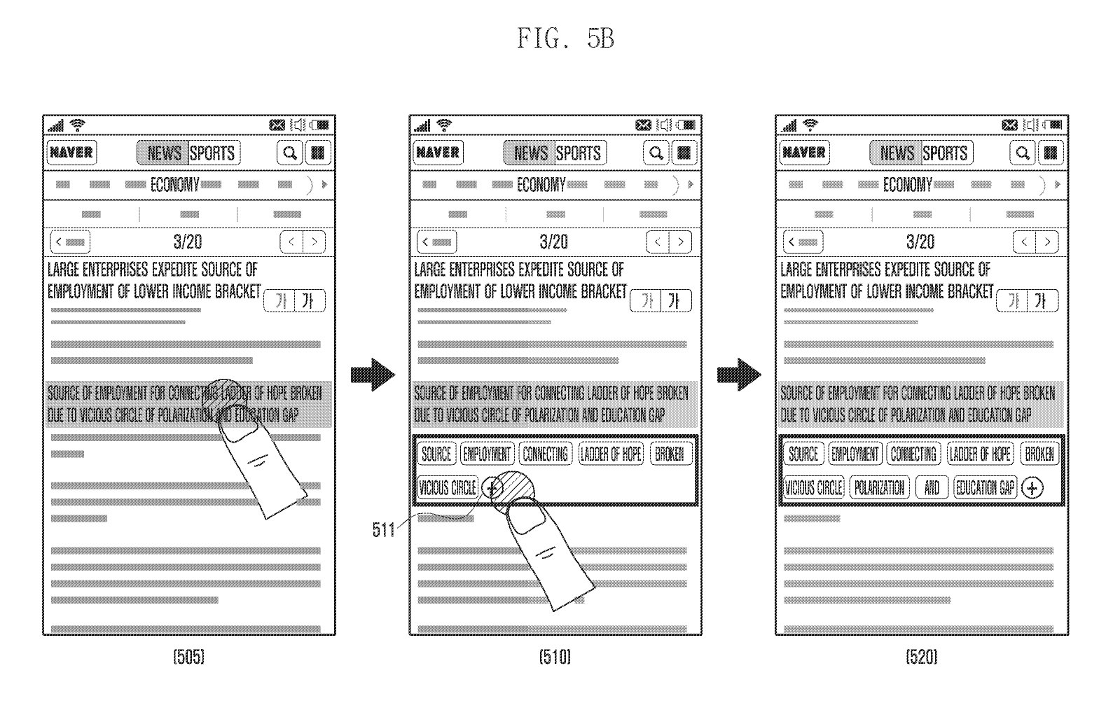

The content of FIG. 4 will be described in more detail with reference to FIGS. 5A and 5B.

FIGS. 5A and 5B are views showing a process of displaying a search keyword when a search is performed according to an embodiment of the present disclosure.

Referring to FIG. 5A, a state in which a sentence of ‘Large enterprises expedite source of employment of lower income bracket’ is selected is illustrated. The control unit 150 may extract search keywords from the selected sentence. According to various embodiments of the present disclosure, the extracted search keywords may be ‘Large enterprises’, ‘expedite’, ‘source of’, ‘employment of’, and ‘lower income bracket’. According to various embodiments of the present disclosure, the control unit 150 may perform a process of determining whether the number of the extracted search keywords is a reference value or more. For example, if the reference is 6, the number of the keywords extracted from FIG. 5A is five, which does not reach the reference value (e.g., the number of keywords extracted is less than the reference value), so that the control unit 150 may display all the extracted search keywords on the popup window 311.

Referring to FIG. 5B, a screen in which the number of extracted search keywords is greater than or equal to a reference value is illustrated. Reference numeral 505 corresponds to a screen showing a state in which the user selects a specific sentence from the contents of an article through a long touch. Then, the selected specific sentence is ‘Source of employment for connecting ladder of hope broken due to vicious circle of polarization and education gap’. The control unit 150 may extract search keywords from the selected specific sentence. The search keywords extracted from the selected specific sentence may be ‘source’, ‘employment’, ‘connecting’, ‘ladder of hope’, ‘broken’, ‘vicious circle’, ‘polarization’, and ‘education gap’. Then, the control unit 150 may identify whether the number of the extracted search keywords is a reference value or more. If it is assumed that the reference is 6, the number of search keywords that can be extracted from the selected specific sentence is the reference value or more. In this case, the search keywords extracted from the selected specific sentence corresponding to the reference value may be selected according to the priority. Because the reference value is 6, the number of selected search keywords may be 6 and only six selected search keywords may be displayed on the popup window 311 as shown in reference numeral 510.

The user may request additional display of search keywords and additionally display hidden search keywords. Reference numeral 510 corresponds to a screen showing a state in which the user selects (e.g., touches) a search keyword adding menu 511 in the popup window 311 and requests additional display of a search keyword. If additional display of a search keyword is requested, as shown in the screen corresponding to reference numeral 520, the control unit 150 may additionally display a hidden search keyword on the popup window 311. According to various embodiments of the present disclosure, when the search keyword adding menu 511 is selected, the control unit 150 may enlarge the size of the popup window 311 and display a hidden search keyword. Alternatively, the user may perform an operation of dragging an edge of the popup window 311 to additionally display a search keyword and enlarging the size of the popup window 311. Alternatively, the user may move a scroll bar (not shown) existing in the popup window 311 to display a hidden search keyword that does not appear on the popup window 311. According to various embodiments of the present disclosure, the control unit 150 may additionally display hidden search keywords corresponding to a predetermined number according to a search keyword adding display request of the user or display all the hidden search keywords on the popup window 311.

Meanwhile, the method of performing a search function in a portable terminal according to various embodiments of the present disclosure may be realized in the form of program instructions that may be performed through various computer means and be recorded in a non-transitory computer readable recording medium. The non-transitory computer readable medium may include a program command, a data file, a data structure, and the like independently or in combination. The program instruction recorded in the recording medium may be specially designed and constructed for the present disclosure, but may be well known to and may be used by those skilled in the art of computer software.

The non-transitory computer readable recording medium may include a magnetic medium such as a hard disc, a floppy disc, and a magnetic tape, an optical recording medium such as a Compact Disc Read Only Memory (CD-ROM) and a Digital Versatile Disc (DVD), a magneto-optical medium such as a floptical disk, and a hardware device specifically configured to store and execute program instructions, such as a Read Only Memory (ROM), a Random Access Memory (RAM), and a flash memory, and/or the like. Further, the program command includes a machine language code generated by a compiler and a high-level language code executable by a computer through an interpreter and the like. The hardware device may be configured to operate as one or more software modules in order to perform operations of the present disclosure, and vice versa.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of performing a search function in a portable terminal, the method comprising:
selecting a text displayed on a screen;
extracting search keywords from the selected text;
displaying the extracted search keywords;
recognizing selection of at least one of the displayed search keywords; and
performing a search using the at least one selected search keyword.

2. The method of claim 1, wherein the selecting of the text comprises performing a preset touch gesture at a point at which the text is located to select the text.

3. The method of claim 1, wherein the extracting of the search keywords comprises:
displaying a popup window overlaid on the screen is if the text is selected; and
displaying the extracted search keywords in the popup window.

4. The method of claim 1, wherein the extracting of the search keywords comprises:
when the number of the search keywords extracted from the selected text is greater than or equal to a reference value, selecting search keywords that are to be displayed, the number of which corresponds to the reference value, from the extracted search keywords according to a priority; and
displaying the selected search keywords.

5. The method of claim 4, wherein the priority comprises at least one of a search frequency in a search engine, an extraction order of the search keywords, user preferences, database storing common keywords, and a display frequency in the text.

6. The method of claim 4, wherein the extracting of the search keywords comprises:
when a request for additional display of a search keyword is made, enlarging a size of the popup window; and
displaying a hidden search keyword of the extracted search keyword on the enlarged popup window.

7. The method of claim 1, wherein the recognizing of the selection of the at least one of the displayed search keywords comprises:
changing at least one of a color, a size, a font, an inclination, and a background color of the selected search keyword; and
displaying the selected search word such that the selection of the search keyword is recognized.

8. The method of claim 1, wherein the performing of the search comprises:
determining whether a search instruction is input by a user while at least one search keyword is selected; and
in response to the search instruction being input, performing a search in a preset search engine.

9. The method of claim 8, wherein the search instruction is input by using one of a method of touching a search button display on the popup window and a method of long-touching a finally selected search keyword.

10. The method of claim 1, wherein the extracting of the the search keywords comprises:
dividing the selected text into at least one of words and phrases.

11. A non-transitory computer-readable storage medium storing instructions that, when executed, cause at least one processor to perfom the method of claim 1.

12. An apparatus for performing a search function in a portable terminal, the apparatus comprising:
a display unit configured to display a text and search keywords extracted from the text;
a touch panel configured to receive a touch gesture generating signal for selecting the text or the extracted search keywords;
a control unit configured to extract search keywords, to detect selection of at least one of the extracted search keywords, and to perform a search using the at least one selected search keyword;
a storage unit configured to store programs and instructions for performing the search; and
a wireless communication unit configured to support wireless communications for performing the search.

13. The apparatus of claim 12, wherein when the touch gesture is performed at a point at which the text is located, the control unit selects the text.

14. The apparatus of claim 12, wherein the control unit displays a popup window overlaid on a screen if the text is selected, and displays the extracted search keywords in the popup window.

15. The apparatus of claim 12, wherein, when then number of the search keywords extracted from the selected text is greater than or equal to a reference value, the control unit selects search keywords that are to be displayed from the extracted search keywords according to a priority, the number of the selected search keywords being a reference value.

16. The apparatus of claim 15, wherein the priority comprises at least one of a search frequency in a search engine, an extraction order of search keywords, user preferences, a database storing common keywords, and a display frequency in the text.

17. The apparatus of claim 15, wherein if an additional display request for a search keyword is made, the control unit enlarges a size of the popup window, and displays a hidden search keyword of the extracted search keywords on the enlarged popup window.

18. The apparatus of claim 12, wherein the control unit changes and displays at least one of a color, a size, a font, an inclination, and a background color of the selected search keyword such that selection of the search keyword is recognized.

19. The apparatus of claim 12, wherein the control unit determines whether a search instruction is input by a user while at least one search keyword is selected, and in response to the search instruction being input, performs a search in a preset search engine.

20. The apparatus of claim 19, wherein the control unit receives a search instruction through one of a method of detecting a touch generated in a search button displayed on the popup window and a method of detecting a touch generated on a finally selected search keyword.

21. The apparatus of claim 12, wherein the control unit extracts the search keywords by dividing the selected text into at least one of words and phrases.
